(19) United States
(12) Patent Application Publication
(10) Pub. No.: US 2016/0039006 A1
(43) Pub. Date: Feb. 11, 2016

(54) Shell and Core Additive Manufacture

(71) Applicant: Caterpillar Inc., Peoria, IL (US)

(72) Inventors: Aaron AMSTUTZ, Peoria, IL (US); Thierry MARCHIONE, Heber City, UT (US)

(73) Assignee: Caterpillar Inc., Peoria, IL (US)

(21) Appl. No.: 14/451,798

(22) Filed: Aug. 5, 2014

(51) Int. Cl. B22F 7/02; B32B 15/01; B29C 70/68; B22F 3/00; B22D 19/00

(52) U.S. Cl. CPC B22F 7/02; B22F 3/00; B22D 19/00; B29C 70/682; B32B 15/01; B32B 15/012; B33Y 80/00

(57) ABSTRACT

A process for manufacturing a part includes forming a shell by an additive manufacturing process, the shell having an interior surface that defines a cavity therein, filling the cavity with a liquid material, applying a heat transfer fluid to the shell during the filling the cavity with the liquid material, and solidifying the liquid material to form a solid core within the shell.

### TECHNICAL FIELD

The present disclosure relates, generally, to additive manufacturing; and, more particularly, to structures and related processes whereby a shell is created by additive manufacturing, a cavity within the shell is filled with an injected or cast material, and the injected or cast material bonds with the shell.

### BACKGROUND

Additive manufacturing is a known technology that continues to evolve, mature, and find new uses and applications. Additive manufacturing processes include three-dimensional printing, whereby material is joined, typically layer-upon-layer, and under computer-directed control, to make a three-dimensional object from electronic data defining a three-dimensional model space. While additive manufacturing is emerging as a powerful process, it currently remains slow as compared with traditional manufacturing processes. Furthermore, the specialized materials needed for additive manufacturing processes are relatively expensive compared to otherwise similar, bulk materials.

Additive manufacturing is often used to manufacture tooling, which is then used to create a manufactured part. For example, additive manufacturing may be used to print a metal mold, which subsequently may be used to create a plastic part.

Alternatively, a master part may be printed, and then tooling may be created from that master part. As an example taken within the context of an investment casting process, a wax master may be printed, an investment casting shell may be built around the wax master, and then the wax master may be melted out of the investment casting shell. The remaining investment casting shell may then be used as the tooling from which a cast—typically metal—part is manufactured.

United States Patent Publication US2013085590 A1 (“the '590 publication”), published Apr. 4, 2013, and entitled “Synthetic Bone Model and Method for Providing Same,” purports to address the problem of providing an inexpensive and rapidly produced synthetic bone model premised upon a patient's bone tissue, whereby a surgeon may use the physical, synthetic bone model to anticipate interoperative difficulties or to test different solutions for the patient's problem, as well as for consultation, experimentation, teaching, and other like purposes. The '590 publication describes a method whereby a file containing data representing a three-dimensional subject bone is provided. Manufacturing instructions are generated based upon at least a portion of the data, and are subsequently transferred to a manufacturing device. A thin-walled outer shell of the synthetic bone model is created, which further defines an inner cavity. A filler material, different from the material of the outer shell, is placed within at least a portion of the inner cavity.

The design and process disclosed within the '590 publication, however, may still produce a less-than-optimal manufactured part, considering variables such as the material used in manufacturing the outer shell, the material used in filling the outer shell, the process used in filling the outer shell, and the thermal differentials developed during the manufacturing process. Accordingly, there is a need for an improved design and process for producing additive manufactured parts.

### SUMMARY

In general, the present disclosure is directed to additive manufacturing of parts, and to processes related thereto.

According to an aspect of the disclosure, a part is manufactured by a process including forming a metallic shell by additive manufacturing, the metallic shell having an interior surface that defines a cavity therein; filling the cavity with a molten metallic material to form a metallic core within the metallic shell; and effecting a metallurgical bond between the metallic core and the metallic shell, such that the metallic shell composes at least a portion of an external surface of the part.

According to another aspect of the disclosure, a process for manufacturing a part includes forming a shell by an additive manufacturing process, the shell having an interior surface that defines a cavity therein; filling the cavity with a liquid material; applying a heat transfer fluid to the shell during the filling the cavity with the liquid material; and solidifying the liquid material to form a solid core within the shell.

According to another aspect of the disclosure, a method for manufacturing a part includes forming a metallic shell by additive manufacturing, the metallic shell having an interior surface that defines a cavity therein; filling the cavity with a molten metallic material to form a metallic core within the metallic shell; and effecting a metallurgical bond between the metallic core and the metallic shell, such that the metallic shell composes at least a portion of an external surface of the part.

These and other aspects of the disclosure will become more apparent to those of ordinary skill in the art after reading the following Detailed Description and the Claims in light of the accompanying drawing Figures.

### BRIEF DESCRIPTION OF THE DRAWINGS

Accordingly, the disclosure will be best understood through consideration of, and with reference to, the following drawing Figures, viewed in conjunction with the Detailed Description referring thereto, and in which:

FIG. 1 shows a perspective view of a part formed according to an aspect of the disclosure;

FIG. 2 illustrates a cross section of a shell, according to an aspect of the disclosure;

FIG. 3 illustrates Detail 3-3 of the shell shown in FIG. 2, according to an aspect of the disclosure;

FIG. 4 illustrated Detail 3-3 of the shell shown in FIG. 2, according to an aspect of the disclosure;

FIG. 5 illustrates a system for filling a shell with a filler material, according to an aspect of the disclosure;

FIG. 6 illustrates a cross sectional view of a part formed according to an aspect of the disclosure; and

FIG. 7 illustrates a process for manufacturing a part, such as the part illustrated in FIGS. 1 and 2, according to an aspect of the disclosure.

The drawings presented are intended solely for the purpose of illustration and that they are, therefore, neither desired nor intended to limit the subject matter of the disclosure to any or all of the exact details of construction shown, except insofar as they may be deemed essential to the claims.

### DETAILED DESCRIPTION

In describing the several aspects of the present disclosure illustrated in the Figures, specific terminology is employed for the sake of clarity. The subject matter of the present disclosure, however, is not intended to be limited to the specific terminology so selected, and it is to be understood that each specific element includes all technical equivalents that operate in a similar manner to accomplish a similar purpose. Additionally, throughout the several Figures, like reference numerals are used to designate like or similar parts unless specified otherwise.

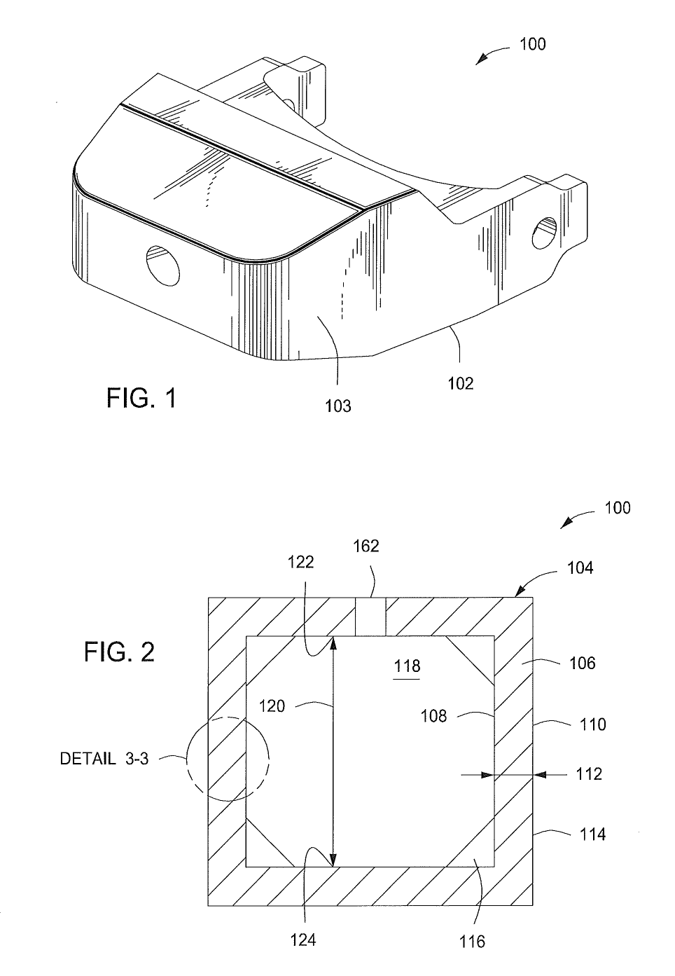

Illustrated in FIGS. 1 and 2 is a part 100. Part 100 may include, for example, a ground engagement tool 102 for an earth-moving machine, although it will be appreciated that the present disclosure is applicable to any of a variety of manufactured parts, across any of a variety of industries, markets, uses, fields, and applications. The part 100 includes a final exterior surface 103, which may be an exterior surface of the part 100 at the time of installing or otherwise incorporating the part 100 into a machine or other commercial product; or at the time the part 100 is ready for installation or incorporation into a machine or other commercial product, for example, as a spare part; or the like.

Best seen in the cross-sectional view of FIG. 2, a shell 104 is created by an additive manufacturing process. Additive manufacturing processes that may be utilized and that are contemplated within the present disclosure include, but are not limited to: stereolithography; photopolymerization stereolithography; mask image stereolithography; metal-sintering; selective laser sintering; direct metal laser sintering; selective laser melting; laser engineered net shaping; wire arc processes; electron beam melting; fused deposition modeling; inkjet deposition; polyjet printing; inkjet material deposition; drop-on-drop material deposition; laminated object manufacturing; subtractive manufacturing processes; combined additive and subtractive manufacturing processes; Arburg Kunststoff free forming; combinations thereof; and any other additive manufacturing, processes know in the art.

The shell 104 includes a wall 106 having an interior surface 108, and an exterior surface 110 opposite the interior surface 108. A distance between the interior surface 108 and the exterior surface 110, through the wall 106, may define a wall thickness 112 of the shell 104. The wall thickness 112 may be a shortest distance between a point on the interior surface 108 and another point on the exterior surface 110. Alternatively, the wall thickness 112 may be defined normal to a point on the interior surface 108, normal to a point on the exterior surface 110, or normal to both the interior surface 108 and the exterior surface 110. The wall thickness 112 may be substantially constant across the shell 104, or the wall thickness 112 may vary with location about the shell 104.

According to an aspect of the disclosure, the wall thickness 112 ranges from about 1 to 5 millimeters. According to another aspect of the disclosure, the wall thickness 112 ranges from about 1 to 3 millimeters. However, persons having skill in the art will appreciate that the wall thickness 112 for the shell 104 of a particular part 100 may be selected to satisfy requirements unique to that particular part 100, or a portion of that particular part 100. In such aspects, the material selected for fabrication of the shell 104 may be engineered with significantly enhanced and/or distinctive properties as compared with conventional coatings, sprays, and the like, of equivalent thickness.

The shell 104 may include a reinforcing or support structure 116. The support structure 116 may be provided for purposes of enhancing the structural integrity of the part 100, the shell 104, or a portion thereof; for purposes of reinforcing the part 100, the shell 104, or a portion thereof; for purposes of enhancing the dimensional stability of the part 100, the shell 104, or a portion thereof; for purposes of stress relief within the part 100, the shell 104, or a portion thereof; for purposes of heat dissemination from, or heat distribution within, the part 100, the shell 104, or a portion thereof; or the like.

A cavity 118 is defined by one or more interior surfaces 108 of the shell 104. For example, the cavity 118 may extend along a direction 120 from a first point 122 on the interior surface 108 to a second point 124 on the interior surface 108. A dimension 120 of the cavity 118 may extend from the first point 122 of the interior surface 108 to the second point 124 of the interior surface 108.

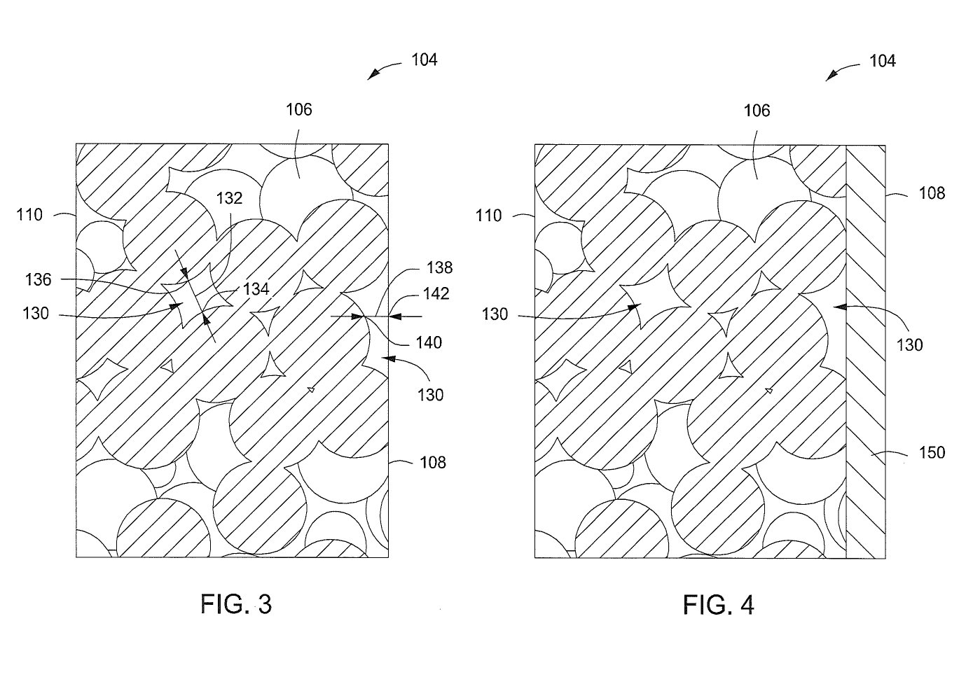

FIG. 3 shows a cross sectional view of a portion of the shell 104 annotated as Detail 2-2 in FIG. 2, according to an aspect of the disclosure. As a result of the additive manufacturing process employed, or other manufacturing step performed on the shell 104, the shell 104 may include open pores or voids 130 defined within the wall 106 of the shell 104. For example, the shell may be additively manufactured from bits of granular material that are adhered, fused, or otherwise bonded to one another at points of contact between adjacent bits of granular material, leaving pores or voids between adjacent bits of granular material that do not share a point of contact. Accordingly, interstitial surfaces within the wall 106 of the shell 104 may define pores or voids 130.

With continued reference to FIG. 3, a dimension 132 of a pore 130 may extend from a first point 134 on a surface defining the pore 130 to a second point 136 on the surface defining the pore 130. Alternatively, or additionally, a dimension 138 of a pore 130 may be bounded in part by the interior surface 108 of the shell 104, such that the dimension 138 extends from a first point 140 on a surface defining the pore to a point 142 on the interior surface 108 of the shell 104.

Characteristic dimensions of a population of pores 130 may be defined by one or more statistical parameters, such as, but not limited to, a most probable pore size, a shape of the pore size distribution, and a parameter characteristic of a width of the pore size distribution. According to an aspect of the disclosure, the most probable pore size may be an average over the population of pores 130, the distribution may be Gaussian, and the width of the distribution may be characterized by a standard deviation of pore sizes over the population of pores 130. According to another aspect of the disclosure a most probable pore size may be a characteristic dimension for a population of pores 130. According to another aspect of the disclosure, an average pore size may be a characteristic dimension for a population of pores 130. It will be appreciated that many different statistical schemes may be similarly applied to characterize a population of pore sizes without departing from the spirit and scope of the present disclosure.

Further, one or more characteristic dimensions for a population of pores 130 within a shell 104 may be related to physical dimensions of a population of granular material used to make the shell, a sintering or other bonding process used to bond adjacent bits of material, or combinations thereof.

According to an aspect of the disclosure, the cavity 118 does not include pores 130 defined within the wall 106. According to another aspect of the disclosure, the cavity 118 does not include pores at least partly defined by the interior surface 108 of the shell 104. According to another aspect of the disclosure, the cavity 118 does not include voids or open volumes having a characteristic dimension 120 that is less than ten times (10×) a characteristic dimension of pores 130 defined within the wall 106 of the shell 104. According to another aspect of the disclosure, the cavity 118 does not include voids or open volumes having a characteristic dimension 120 that is less than one hundred times (100×) a characteristic dimension of pores 130 defined within the wall 106 of the shell 104.

FIG. 4 shows a cross sectional view of a portion of the shell 104 annotated as Detail 2-2 in FIG. 2, according to an aspect of the disclosure. Similar to the shell 104 shown in FIG. 3, the shell 104 in FIG. 4 includes voids or pores 130 defined by interstitial surfaces within the wall 106. In addition, however, at least a portion of interior surface 108 of the shell 104 of FIG. 4 is defined by an impermeable layer 150. The impermeable layer 150 may be impermeable to specific liquids such as, but not limited to, polymeric resins, molten metals, and the like; impermeable to gases, such as, but not limited to, nitrogen, standard air, and the like; impermeable to liquids yet permeable to gases; or impermeable to both liquids and gases. According to an aspect of the disclosure, substantially all of the interior surface 108 of the shell 104 is defined by an impermeable layer 150.

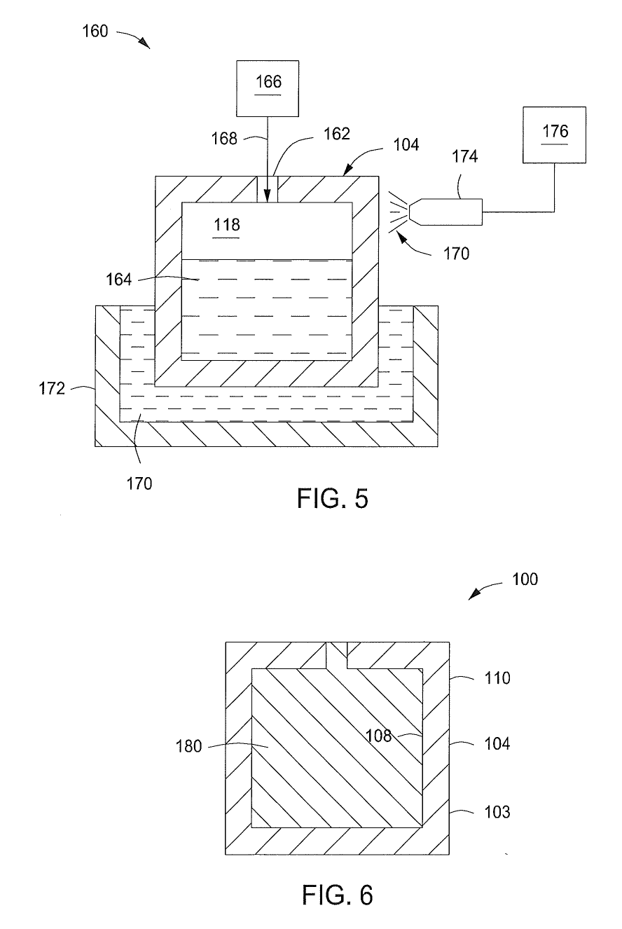

FIG. 5 shows a schematic view of a system 160 for filling a cavity 118 of a shell 104, according to an aspect of the disclosure. The interior surface 108 of the shell 104 may define an aperture 162 through the wall 106 of the shell 104, such that the cavity 118 may be filled with a fluid filler material 164 via the aperture 162. The cavity 118 may be filled with the fluid filler material 164 in a liquid or slurry state through an injection process, a casting process, or the like.

As shown in FIG. 5, the aperture 162 may be in fluid communication with a source of the fluid filler material 166 during the filling process. Accordingly, the cavity 118 of the shell 104 may receive a flow 168 of the fluid filler material 164 from the source of the fluid filler material 166. According to an aspect of the disclosure, the fluid filler material 164 fills at least a portion of the cavity 118 but does not fill any pores 130 (see FIGS. 3 and 4) within the wall 106 of the shell 104. The fluid filler material 164 may fill a portion of the cavity 118 but not a substantial number of pores 130 because the interior surface 108 of the shell 104 is impermeable to the fluid filler material 164, insufficient capillary flow potential exists between the fluid filler material 164 and the pores 130, combinations thereof, or other physical process preventing fluid filler material 164 from flowing from the cavity 118 into a substantial number of the pores 130.

According to another aspect of the disclosure, the fluid filler material 164 fills at least a portion of the cavity 118 and at least a substantial number of pores 130 within the wall 106 of the shell 104. Herein, a number of pores 130 filled with fluid filler material 164 may be substantial when such pore filling substantially affects an overall porosity of the shell 104, a density of the shell 104, or combinations thereof. A substantial effect on an overall porosity of the shell 104, or a density of the shell 104, may be a change in either or both greater than 3%.

According to another aspect of the disclosure, the cavity 118 does not include voids or open volumes having a characteristic dimension 120 that is less than a wall thickness 112 of the shell 104. According to another aspect of the disclosure, the cavity 118 does not include voids or open volumes having a characteristic dimension 120 that is less than five times (5×) a wall thickness 112 of the shell 104.

In some aspects of the present disclosure, the shell 104 is filled with the fluid filler material 164 while the shell 104 is immersed in, or sprayed or otherwise quenched with, a heat transfer fluid 170. For example, a least a portion of the exterior surface 110 of the shell 104 may be immersed in a pool of heat transfer fluid 170 contained within a basin 172. Alternatively, or in addition, heat transfer fluid 170 may be sprayed onto a least a portion of the exterior surface 110 of the shell 104 via a spray nozzle 174 in fluid communication with a source of heat transfer fluid 170.

FIG. 6 shows a cross sectional view of a part 100, according to an aspect of the disclosure. Fluid filler material 164 delivered to the cavity 118 of the shell 104 may solidify into a solid filler material 180 by transferring heat out of the fluid filler material 164, through chemical reactions between constituents of the fluid filler material 164, combinations thereof, or other solidification process known to persons having skill in the art. In some aspects of the present disclosure, bonding may occur by appropriate selection of materials, such that melt infusion-type bonding occurs between the filler material 164 and the material of the shell 104; notwithstanding, this is not an express requirement of any aspect of the present disclosure. Rather, simple molecular exchange bonding, or the like, is sufficient, and will most often be the principal means of bonding given the typical, fully densified structure provided by the shell 104.

As the part 100 is so-formed, the fluid filler material 164 may bond with the shell 104 while in a fluid state, the fluid filler material 164 may bond with the shell 104 during the process of solidification, the solid filler material 180 may bond with the shell 104 from a solid state, or combinations thereof. Accordingly, the solid filler material 180 is bound to the interior surface 108 of the shell, such that the exterior surface 110 of the shell 104 defines at least a portion of the final exterior surface 103 of the manufactured part 100.

According to an aspect of the disclosure, the part 100 is rendered in a finished state without separating a substantial amount of the shell 104 from the solid filler material 180 at the boundary between the solid filler material 180 and the interior surface 108 of the shell 104. By comparison, it will be understood that releasing a cast part from its mold constitutes substantial separation between the cast part and its mold.

### INDUSTRIAL APPLICABILITY

The present disclosure is applicable, in general, to additive manufactured parts and processes therefor; and, more particularly, to an additive manufactured part whereby a hollow shell, in some aspects including minimal supporting structure, is created by additive manufacturing, a hollow space within the shell being filled with an injected or cast material. It will be appreciated that the shell 104 may assume any shape desired for manufacture of the part 100.

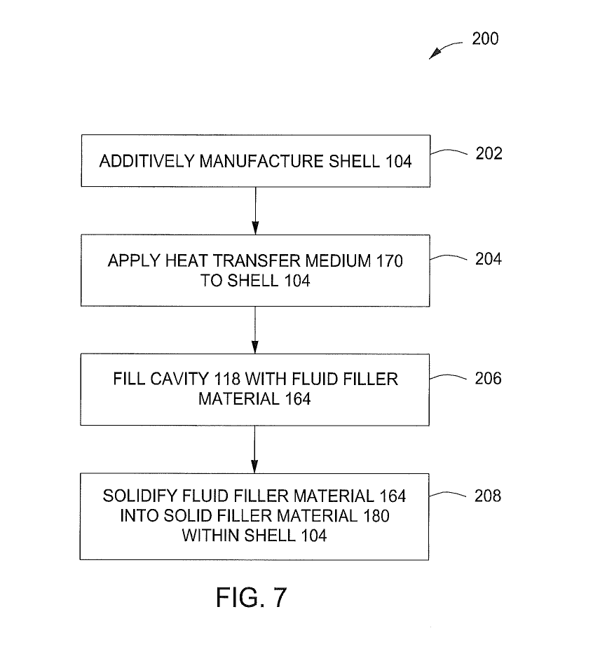

With continuing reference to FIGS. 1-6, and with particular reference to FIG. 7, a process 200 for additively manufacturing a part 100 may comprise the following steps. At step 202, a shell 104 is manufactured by any one of a variety of available, selected additive manufacturing processes. The shell 104 comprises at least some external dimensions and features of a finished, desired part 100, and further comprises a substantially hollow cavity 118 within the shell 104. At step 204, the shell 104 is immersed in, or sprayed or otherwise quenched with, a heat transfer medium 170 so as promote dimensional stability of the shell 104, the part 100, or both. At step 206, the cavity 118 is filled, as by injection or casting process, with a fluid filler material 164 that is selected to bond with the shell 104. At step 208, the fluid filler material 164 solidifies into a solid filler material 180 within the shell 104.

In some aspects of the present disclosure, such as for example, for plastic parts 100, the shell 104 may be constructed with a plurality of support structures 116, such as supporting ribs, walls, or columns, for purposes such as to maintain dimensional stability of a part 100 when secondary, filler material 164 is injected into internal cavity 118.

The solid filler material 180 may have properties similar to or complementary to those of a material forming the shell 104. For example, if the shell 104 is relatively soft and flexible, the filler material 164 may include a higher modulus material, such as a resin that, in turn, may contain reinforcing materials, including, but not limited to, glass fibers, carbon fibers, mineral fillers, and the like. As well, filler material 164 may be based upon a two-part polymer chemistry or system, including, but not limited to, epoxy resins, polyurethane resins, acrylic resins, phenolic resins, polydicyclopentadiene (“DCPD”) resins, polycaprolactone -based resins, polyester resins, vinyl ester resins, cementitious materials, and the like. In a case where the fluid filler material 164 comprises such a resin, a moderate heating cycle may be required to complete the curing reaction. Alternatively, the shell 104 may be filled with a liquefied thermoplastic polymer resin by heating the resin past its melting point. Such resins may be selected from those known as hot melt adhesives, including but not limited to polyamide hot melts, ethylene vinyl acetate hot melts, polyester hot melts, polyurethane hot melts, and amorphous poly-alpha-olefin hot melts. Resins may also be selected from known thermoplastic resins that are typically used for injection molding where the temperature is increased substantially above the melting point typically used in an injection molding machine in order to reduce the viscosity for low pressure casting.

In some aspects of the present disclosure, as used for heated thermoplastic resins, in order to effect a beneficial cooling rate and to prevent rupture, blowout, disfigurement, distortion, cracking, melting, and other damage of the shell 104, the entirety of at least filling the part 100 with filler material 164 may take place with the shell 104 partially or wholly immersed in an appropriate cooling medium 170. The cooling medium may be selected from media such as water, oil, water-oil emulsions, silicone oil, and the like. Alternatively, or in addition, in some aspects of the present disclosure, adequate heat transfer may be achieved by spraying the shell 104 with an appropriate fluid, gas, fluid-gas mixture, and/or the like. Still alternatively, or in addition, in some aspects of the present disclosure, adequate heat transfer may be achieved by fixture quenching, whereby the shell 104 is held or clamped, while a quenching medium is rapidly applied thereto.

For such plastic parts 100, the shell 104 may be formed from any of the known additive manufacturing technologies conducive for use with plastics, including, but not limited to, stereolithography, polyjet printing, fused deposition modeling, selective laser sintering, selective laser melting, Arburg Kunststoff plastic free forming, and the like. In some aspects of the present disclosure, the material used in forming the shell 104 is selected in order to ensure adequate bonding with the fluid filler material 164, solid filler material 180, or both.

In some aspects of the present disclosure, such as for example, for metal parts 100, the shell 104 may be formed from any of the known additive manufacturing technologies conducive for use with metals, including, but not limited to, direct metal laser sintering, laser engineered net shaping, wire arc processes, and variations thereof. After the shell 104 is formed, a molten metal filler material 164, such as, for example, steel, cast iron, aluminum, or the like, is poured or injected into the cavity 118 formed by the shell 104. The filler material 164 is selected in order to ensure adequate metallurgical bonding with the additive manufactured shell 104.

In some aspects of the present disclosure, in order to effect a beneficial cooling rate and to prevent rupture, blowout, disfigurement, distortion, cracking, melting, and other damage, of the shell 104, the entirety of at least filling the part 100 with filler material 164 may take place with the shell 104 partially or wholly immersed in an appropriate cooling medium 170. The cooling medium may be selected from media such as water, oil, water-oil emulsions, molten salt, fluidized beds, molten tin, silicone oil, and the like. Alternatively, or in addition, in some aspects of the present disclosure, adequate heat transfer may be achieved by spraying the shell 104 with an appropriate fluid, gas, fluid-gas mixture, and/or the like. Still alternatively, or in addition, in some aspects of the present disclosure, adequate heat transfer may be achieved by fixture quenching, whereby the shell 104 is held or clamped, while a quenching medium is rapidly applied thereto.

According to an aspect of the disclosure, the heat transfer medium 170 is a liquid having a specific heat greater than that of ambient air. According to another aspect of the disclosure, the heat transfer medium 170 is a gas driven under forced convection around the part 100.

The additive manufactured shell 104 may be selected so as to provide a superior performance criterion or metallurgic property as compared with a fluid filler material 164 selected to fill the cavity 118. For example, but not limitation, the material forming the shell 104 may be selected to comprise better corrosion resistance, such as may be obtained through use of stainless steel, TiA16V4 (a high strength titanium alloy), or the like; it may be selected to comprise higher strength, such as may be obtained through use of maraging steel, or the like; and/or it may be selected to comprise higher hardness, such as may be obtained through use of carbide-containing alloys, or the like.

Alternatively, it is possible to fill a metal shell 104 with a polymer-based resin. Further alternatively, it is possible to fill a high temperature thermoplastic shell 104 with a relatively low melting point metal, such as, by way of non-limiting example, tin and bismuth alloys, and the like. In the latter example, full or partial immersion of the shell 104 in an appropriate cooling medium 170 may be beneficial to prevent rupture, blowout, disfigurement, distortion, cracking, melting, or other damage, of the shell 104 when filled with the filler material 164, as previously described. Alternatively, or in addition, in some aspects of the present disclosure, adequate heat transfer may be achieved by spraying the shell 104 with an appropriate fluid, gas, fluid-gas mixture, and/or the like, or by fixture quenching as described above.

Accordingly, and sometimes beneficially, part 100 formed as described above may be provided at lower cost, considering fabrication time, material costs, and the like, while sometimes beneficially improving the properties of the final part through synergies between the material of the shell 104 and that of filler material 164. By way of example, but not limitation, the material selected for use in forming shell 104 may provide for a highly engineered surface, while the material selected for use as a filler material 164 may provide for a lower cost core. As an example, a minimally porous or non-porous shell 104, such as may be formed from a carbide-containing metal, may surround the solid filler material 180 in the part 100, which provides for toughness, such as by use of cast steel, for ductility, such as by use of ductile iron, brass, or bronze; for lighter weight, such as by use of aluminum; and the like. In some aspects, the exterior surface 110 of the shell 104 may be sufficiently formed so that no further post-fabrication finishing or post-fabrication heat treatment of the part 100 is necessary.

Further, it may sometimes be beneficial to fabricate a metallic shell 104 by an additive manufacturing process, and inject or cast a molten metal within the cavity 118 formed by the shell 104. Still further, it may sometimes be beneficial to immerse a metallic shell 104 in, or spray or otherwise quench it with, a heat transfer medium 170 during injection or casting so as to prevent damage to the shell 104 and the part 100.

Having thus described exemplary aspects of the subject matter of the present disclosure, it is noted that the within disclosures are exemplary only and that various other alternatives, adaptations, and modifications may be made within the scope and spirit of the present disclosure. Accordingly, the present subject matter is not limited to the specific aspects illustrated herein, but is only limited by the following claims.

We claim:

1. A part manufactured by a process, the process comprising:
forming a metallic shell by additive manufacturing, the metallic shell having an interior surface that defines a cavity therein;
filling the cavity with a molten metallic material to form a metallic core within the metallic shell; and
effecting a metallurgical bond between the metallic core and the metallic shell, such that the metallic shell composes at least a portion of an external surface of the part.

2. The part of claim 1, wherein the process further comprises solidifying the molten metallic material within the metallic shell, and the process does not include separating substantially all of the metallic shell from the metallic core after the solidifying the molten metallic material.

3. The part of claim 1, wherein the process further comprises filling pores within a wall of the metallic shell with the molten metallic material in addition to the filling the cavity with the molten metallic material.

4. The part of claim 1, wherein the interior surface of the metallic shell is substantially impermeable to the molten metallic material.

5. The part of claim 2, wherein a material of the metallic shell is selected from the group consisting of stainless steel, TiA16V4, maraging steel, and carbide-containing alloys.

6. The part of claim 1, wherein the metallic shell further comprises a support structure disposed within the cavity.

7. The part of claim 1, wherein a material of the metallic core is selected from the group consisting of tin alloys, bismuth alloys, tin and bismuth alloys, cast steel, ductile iron, brass, bronze, and aluminum.

8. The part of claim 1, wherein a material of the metallic shell is different from a material of the metallic core.

9. The part of claim 8, wherein a hardness of the material of the metallic shell is greater than a hardness of the material of the metallic core.

10. The part of claim 8, wherein a ductility of the material of the metallic core is greater than a ductility of the material of the metallic shell.

11. The part of claim 8, wherein the cavity does not include voids having a characteristic dimension that is less than one hundred times a characteristic dimension of pores defined within a wall of the metallic shell.

12. The part of claim 1, wherein the process further comprises applying a heat transfer medium to the metallic shell during the filling the cavity with the molten metallic material.

13. A process for manufacturing a part, comprising:
forming a shell by an additive manufacturing process, the shell having an interior surface that defines a cavity therein;
filling the cavity with a liquid material;
applying a heat transfer fluid to the shell during the filling the cavity with the liquid material; and
solidifying the liquid material to form a solid core within the shell.

14. The process of claim 13, wherein the shell is metallic.

15. The part of claim 14, wherein the liquid material comprises a polymer-based resin.

16. The process of claim 13, wherein the shell composes at least a portion of a final exterior surface of the part.

17. The process of claim 13, wherein the liquid material is a molten metallic material.

18. The process of claim 13, wherein the applying a heat transfer fluid to at least a portion of the shell is accomplished by at least one of immersing the shell in the heat transfer fluid, spraying the heat transfer fluid onto the shell, and fixture quenching the shell using the heat transfer fluid.

19. A method for manufacturing a part comprising the steps of:
forming a metallic shell by additive manufacturing, the metallic shell having an interior surface that defines a cavity therein;
filling the cavity with a molten metallic material to form a metallic core within the metallic shell; and
effecting a metallurgical bond between the metallic core and the metallic shell, such that the metallic shell composes at least a portion of an external surface of the part.

20. The method of claim 19, further comprising applying a heat transfer fluid to at least a portion of the metallic shell during the filling the cavity with the molten metallic material.
